(19) United States
(12) Patent Application Publication
(10) Pub. No.: US 2013/0063515 A1
(43) Pub. Date: Mar. 14, 2013

(54) INKJET LINE PRINTER

(71) Applicants: Masashi NAKATSU, Azumino-shi (JP); Yasumichi OKUDA, Matsumoto-shi (JP); Hiroshi HAMAKAWA, Matsumoto-shi (JP); Hiroki SHINAGAWA, Matsumoto-shi (JP)

(72) Inventors: Masashi NAKATSU, Azumino-shi (JP); Yasumichi OKUDA, Matsumoto-shi (JP); Hiroshi HAMAKAWA, Matsumoto-shi (JP); Hiroki SHINAGAWA, Matsumoto-shi (JP)

(73) Assignee: SEIKO EPSON CORPORATION, Tokyo (JP)

(21) Appl. No.: 13/570,353

(22) Filed: Aug. 9, 2012

(30) Foreign Application Priority Data
Sep. 8, 2011 (JP) 2011-195747

(51) Int. Cl. B41J 29/38

(52) U.S. Cl. 347/16

(57) ABSTRACT

An inkjet line printer has a first encoder for detecting the media conveyance distance of the paper feed roller, and a second encoder for generating a signal to control the ink ejection timing. The encoder scales of the first encoder and second encoder are disposed to the intermediate roller of a speed reducing mechanism that transfers drive power from the paper feed motor to the paper feed roller. Because the second encoder outputs a pulse signal with a predetermined number of pulses in the time the recording paper is conveyed a specific distance by the paper feed roller, the signal from the second encoder can be used as a signal to control the timing of ink ejection from the inkjet head.

### BACKGROUND

1. Technical Field

The present invention relates to an inkjet line printer that gets a signal for determining the ink ejection timing from an encoder.

2. Related Art

Inkjet printers are commonly serial inkjet printers that print on recording paper by alternately performing a paper feed operation that conveys the recording paper through a conveyance path past the printing position, and an ink ejection operation that ejects ink onto the recording paper at the printing position while moving the inkjet head mounted on a carriage widthwise to the paper perpendicularly to the conveyance direction. A serial inkjet printer of this type is described in Japanese Unexamined Patent Appl. Pub. JP-A-H09-24653.

The serial inkjet printer described in JP-A-H09-24653 has a motor encoder for detecting the conveyance distance of the recording paper, and a linear encoder for detecting the position of the inkjet head widthwise to the paper, and controls ink ejection by the inkjet head based on signals from the motor encoder and signals from the linear encoder.

Another type of inkjet printer is the inkjet line printer, which has an inkjet head that is wider than the print area on the recording paper. Because the inkjet head of an inkjet line printer is stationary when printing, a linear encoder is not needed to detect the position of the inkjet head widthwise to the paper, and there is no need to determine the timing of ink ejection from the inkjet head based on the position information output from the linear encoder.

However, because ink is ejected from the inkjet head simultaneously to media conveyance in an inkjet line printer, the timing of ink ejection must be controlled based on the position of the inkjet head in the media conveyance direction. Because the position of the inkjet head in the media conveyance direction is output as a signal from an encoder such as the motor encoder in JP-A-H09-24653 that detects the media conveyance distance, the ink ejection timing of the inkjet head can be determined using signals from the encoder. However, because a high resolution encoder is used to detect the media conveyance distance in order to control the paper feed operation with good precision, using the encoder signal directly as a signal for determining the ink ejection timing is difficult.

### SUMMARY

An inkjet line printer according to the present invention has a configuration that can easily acquire a signal for controlling the ink ejection timing.

A first aspect of the invention is an inkjet line printer including: a paper feed roller that conveys recording paper through a conveyance path past the printing position of an inkjet head; a paper feed motor that rotates the paper feed roller; a first encoder that detects the conveyance distance of the paper feed roller; a second encoder that generates a signal controlling the ink ejection timing of the inkjet head; and a speed reducing mechanism that slows and transfers rotation of the paper feed motor to the paper feed roller, and has an intermediate roller that rotates at a slower speed than the paper feed motor shaft and a higher speed than the paper feed roller. A first encoder scale of the first encoder and a second encoder scale of the second encoder are disposed to the intermediate roller of the speed reducing mechanism.

This aspect of the invention has a first encoder for detecting the paper feed distance of the paper feed roller, and a separate second encoder for generating a signal that controls the ink ejection timing of the inkjet head. The first encoder has suited to controlling media conveyance, and the second encoder has resolution suited to controlling ink ejection. As a result, a signal suited to controlling the ink ejection timing of the inkjet head can be acquired from the second encoder.

The second encoder scale and the first encoder scale rotate in unison because the second encoder scale of the second encoder is attached to the intermediate roller in unison with the first encoder scale of the first encoder that detects the media conveyance distance. As a result, no offset occurs between the signal output from the second encoder and the signal output from the first encoder, and ink can therefore be accurately ejected from the inkjet head based on the position of the inkjet head in the paper conveyance direction.

In addition, because the encoder scales are attached to an intermediate roller that rotates faster than the paper feed roller, the diameters of the encoder scales can be smaller than when the encoder scales are attached to the paper feed roller shaft.

In another aspect of the invention, the resolution of the first encoder is preferably higher than the resolution of the second encoder so that the resolution of the first encoder is suited to paper feed control and the resolution of the second encoder is suited to ink ejection control.

Further preferably, to attach the first encoder scale of the first encoder and the second encoder scale of the second encoder to the intermediate roller, the first encoder scale is disposed to a first disk attached coaxially to the intermediate roller, and the second encoder scale is disposed to a second disk attached coaxially to the intermediate roller at a different position than the first disk in the axial direction of the intermediate roller.

In another aspect of the invention, the first encoder scale of the first encoder and the second encoder scale of the second encoder are disposed at different radial positions on a single disk attached coaxially to the intermediate roller. This configuration uses a single disk to provide both encoder scales, and can therefore reduce the parts count.

A speed reducing mechanism with an intermediate roller can be easily configured using a first pulley attached to the output shaft of the paper feed motor; a second pulley that is attached coaxially to the intermediate roller and has a larger diameter than the first pulley; a third pulley that is attached coaxially to the intermediate roller and has a smaller diameter than the second pulley; a fourth pulley that is that is attached coaxially to the paper feed roller and has a larger diameter than the paper feed roller and the third pulley; a first endless belt that is mounted on the first pulley and second pulley; and a second endless belt that is mounted on the third pulley and fourth pulley.

### Effect of the invention

The invention can acquire a signal suitable for controlling the ink ejection timing of an inkjet head from a second encoder.

Because the second encoder scale and the first encoder scale rotate in unison and there is no offset between the signal output from the second encoder and the signal output from the first encoder, ink can be precisely ejected from the inkjet head.

In addition, because the encoder scales are attached to an intermediate roller that rotates faster than the paper feed roller, smaller diameter encoder scales can be used than if the encoder scales are attached to the paper feed roller shaft.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is a vertical section view showing the general configuration of a printer according to a preferred embodiment of the invention.

FIG. 2 is a plan view of the inkjet head from the nozzle face side.

FIG. 3 describes the speed reducing mechanism and control system for controlling the printing operation.

### DESCRIPTION OF EMBODIMENTS

A preferred embodiment of an inkjet line printer according to the present invention is described below with reference to the accompanying figures.

### General Configuration

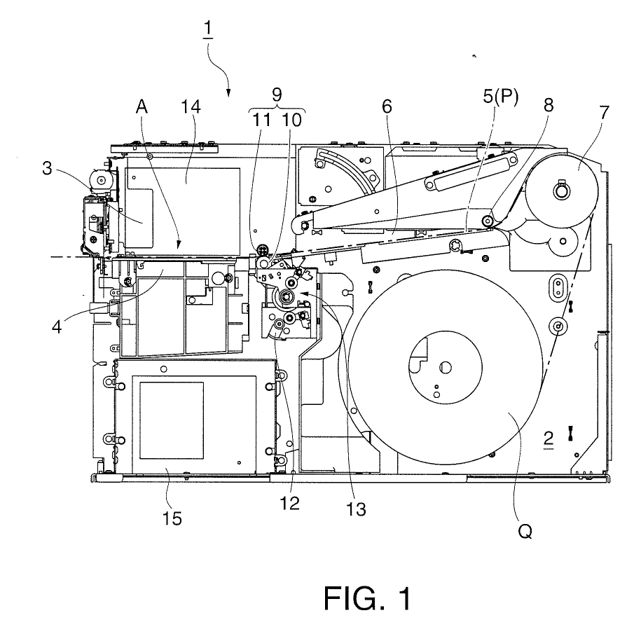

FIG. 1 is a vertical section view showing the general configuration of an inkjet line printer according to a preferred embodiment of the invention. An inkjet line printer 1 according to this embodiment of the invention prints on continuous recording paper P using plural colors of ink. A roll paper compartment 2 is provided at the back of the inkjet line printer 1, and the recording paper P pulled from the paper roll Q stored in the roll paper compartment 2 is conveyed through a conveyance path 5 past the surface of a platen 4 that defines the printing position A of the inkjet head 3.

A paper guide 6 for preventing skewing of the recording paper P is disposed above the roll paper compartment 2, and a supply roller 7 that pulls the recording paper P from the paper roll Q is disposed behind the paper guide 6. A supply motor not shown rotates the supply roller 7 forward and reverse.

The recording paper P is pulled from the paper roll Q at an angle to the back towards the supply roller 7, and then winds around the supply roller 7. After being pulled forward around the supply roller 7, the recording paper P passes a load roller 8 disposed behind the paper guide 6, passes over the paper guide 6 and through the paper feed roller pair 9 located in front of the paper guide 6, and then passes over the surface of the platen 4. The paper feed roller pair 9 includes a paper feed roller 10 that contacts the recording paper P from below, and a pressure roller 11 that is urged from above to the paper feed roller 10 side. A paper feed motor 12 that rotates the paper feed roller 10 forward and reverse is disposed below the paper feed roller pair 9. A speed reducing mechanism 13 that slows and transfers rotation of the paper feed motor 12 to the paper feed roller 10 is disposed between the paper feed motor 12 and paper feed roller 10.

The inkjet head 3 is mounted on a carriage 14 above the platen 4. An ink cartridge unit 15 is disposed below the platen 4. Ink cartridges storing four colors of ink, cyan, magenta, yellow, and black, are loaded in the ink cartridge unit 15. When an ink cartridge is loaded in the ink cartridge unit 15, a pump mechanism not shown for supplying ink is connected to an ink tank inside the ink cartridge, and ink can be supplied to the inkjet head 3.

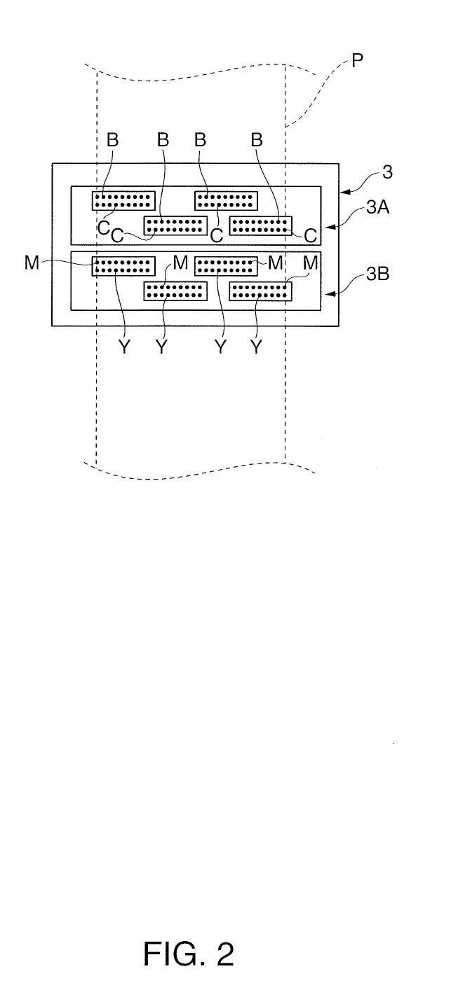

FIG. 2 is a plan view of the inkjet head 3 from the nozzle face side. As shown in FIG. 2, the inkjet head 3 is a compound head including a first head 3A and a second head 3B, the first head 3A having ink nozzle row B that ejects black ink and ink nozzle row C that ejects cyan ink, and the second head 3B having ink nozzle row M that ejects magenta ink and ink nozzle row Y that ejects yellow ink. The first and second first heads 3A and 3B are wider than the recording paper P, the ink nozzle rows B, C, M, Y extend across the width of the recording paper P (widthwise to the printer), and are disposed in an area of a width completely covering the print area on the recording paper P.

When mounted on the carriage 14, the inkjet head 3 can move bidirectionally between the printing position A shown in FIG. 1, and a home position (not shown in the figure) removed widthwise to the printer outside of the conveyance path 5. When stopped at the printing position A, the inkjet head 3 prints on the recording paper P conveyed through the conveyance path 5, and when printing ends retreats to and waits at the home position. A maintenance operation to prevent or remove ink clogging the ink nozzles of the inkjet head 3 is performed when the inkjet head 3 is at the home position.

When recording paper P pulled from the paper roll Q is loaded in the conveyance path 5 and a print command is received, the inkjet line printer 1 moves the inkjet head 3 from the home position toward the printing position A, and positions and stops the inkjet head 3 at the printing position A. A paper feed operation that rotates the paper feed roller 10 and conveys the recording paper P, and an ink ejection operation that ejects ink from the inkjet head 3 to the recording paper P, then run in parallel to print on the recording paper P passing the printing position A.

### Speed Reducing Mechanism

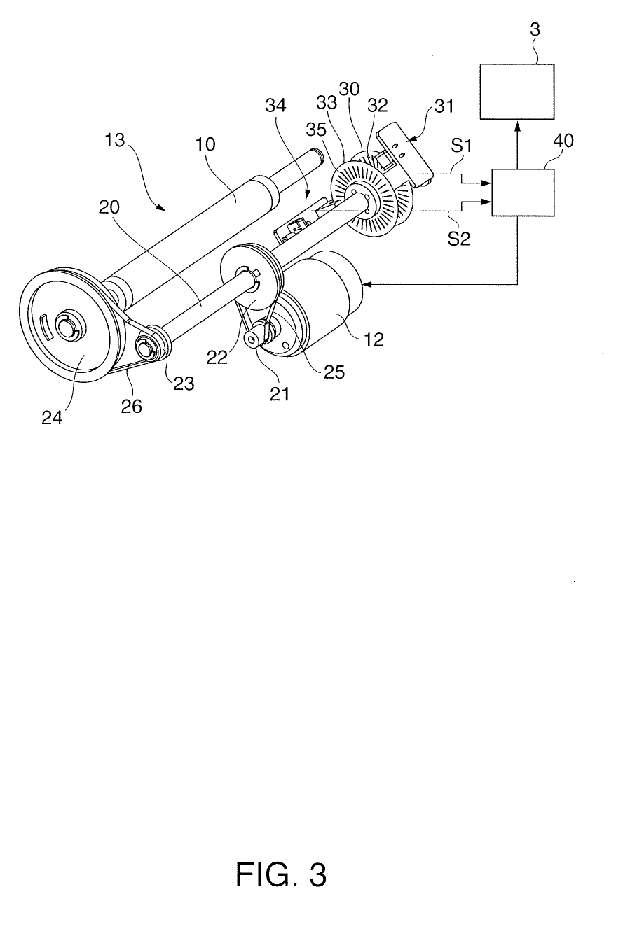

FIG. 3 describes the control system that controls the speed reducing mechanism 13 and printing operation. The speed reducing mechanism 13 has an intermediate roller 20 disposed parallel to the paper feed roller 10. The speed reducing mechanism 13 also includes a first pulley 21 attached to the output shaft of the paper feed motor 12, a second pulley 22 that is larger than the first pulley 21 and is attached coaxially to the intermediate roller 20, a third pulley 23 that is smaller than the second pulley 22 and is attached coaxially to the intermediate roller 20, and a fourth pulley 24 that is larger than the paper feed roller 10 and third pulley 23 and is attached coaxially to the paper feed roller 10. The second pulley 22 is affixed to the middle of the intermediate roller 20 in the axial direction, and the third pulley 23 is affixed to one end of the intermediate roller 20. The fourth pulley 24 is affixed to one end of the paper feed roller 10. A first endless belt 25 is mounted on the first pulley 21 and second pulley 22, and a second endless belt 26 is mounted on the third pulley 23 and fourth pulley 24. The intermediate roller 20 of the speed reducing mechanism 13 rotates more slowly than the paper feed motor 12, and faster than the paper feed roller 10. In this embodiment the speed reducing ratio of the intermediate roller 20 and the paper feed roller 10 is 4:1.

### Control System

A first disk 30 is affixed coaxially to the intermediate roller 20 at the other end of the intermediate roller 20, and a first encoder scale 32 of a first encoder 31 is disposed to the first disk 30.

A second disk 33 is affixed coaxially to the intermediate roller 20 at a position separated to the inside from the first disk 30 in the axial direction of the intermediate roller 20, and a second encoder scale 35 of a second encoder 34 is disposed to the second disk 33.

In this embodiment each of the encoder scales 32, 35 is a series of slits formed at an equiangular interval around the outside edge of the respective disks 30, 33, and the encoders 31, 34 optically detect movement of the slits. The resolution of the first encoder 31 is greater than the resolution of the second encoder 34, and in this embodiment the resolution of the first encoder 31 is four times the resolution of the second encoder 34.

The first encoder 31 detects the conveyance distance of the recording paper P by the paper feed roller 10, and a first signal S1 output from the first encoder 31 is input to print control unit 40 that controls the printing operation of the inkjet line printer 1.

The print control unit 40 is an electronic circuit including a CPU and ROM that stores firmware, controls the paper feed motor 12 based on the first signal S1, and controls the conveyance distance of the recording paper P by the paper feed roller 10.

The second encoder 34 generates a second signal S2 that controls the ink ejection timing of the roll paper compartment 2, and the second signal S2 output from the second encoder 34 is also input to the print control unit 40. The second signal S2 output from the second encoder 34 is a pulse signal of a predetermined number of pulses (a number dependent upon the resolution) in one revolution of the intermediate roller 20, that is, in the time the required for the paper feed roller 10 to convey the recording paper a specific distance. Based on this pulse signal, the print control unit 40 generates a drive signal for ejecting ink from the ink nozzles of the ink nozzle rows B, C, M, Y in the inkjet head 3. The print control unit 40 drives the piezo actuators of the inkjet head 3 based on the generated drive signal and thereby ejects ink from the inkjet head 3.

### Operating Effect

This embodiment of the invention has a first encoder 31 for detecting the paper feed distance of the paper feed roller 10, and a separate second encoder 34 for generating a signal that controls the ink ejection timing of the inkjet head 3. The first encoder 31 is a high resolution encoder suited to controlling media conveyance, and the second encoder 34 has resolution suited to controlling ink ejection. As a result, a signal suited to controlling the ink ejection timing of the inkjet head can be acquired from the second encoder 34.

In this embodiment the second encoder scale 35 and the first encoder scale 32 rotate in unison because the second encoder scale 35 of the second encoder 34 is attached to the intermediate roller 20 in unison with the first encoder scale 32 of the first encoder 31 for detecting the media conveyance distance. As a result, no offset occurs between the signal output from the second encoder 34 and the signal output from the first encoder 31, and the print control unit 40 can therefore cause ink to be accurately ejected from the inkjet head 3.

Furthermore, because the encoder scales 32, 35 are attached to the intermediate roller 20, which rotates faster than the paper feed roller 10, smaller diameter scales can be used than when the annular encoder scales 32, 35 are attached to the paper feed roller 10 shaft. Because the diameter of the disks 30, 33 to which the encoder scales 32, 35 are disposed can therefore be suppressed, interference between the disks 30, 33 and the inkjet head 3 and carriage 14 that move widthwise to the printer above the conveyance path 5 can be avoided when the inkjet head 3 mounted on the carriage 14 moves between the printing position A and the home position.

### Other Embodiments

The first encoder scale 32 of the first encoder 31, and the second encoder scale 35 of the second encoder 34, are disposed on different disks in the embodiment described above, but could be disposed at different radial positions on a single disk attached coaxially to the intermediate roller 20. More specifically, the lower resolution second encoder scale 35 of the second encoder 34 could be disposed inside the first encoder scale 32 of the first encoder 31 in the radial direction. This enables using a single disk with both encoder scales, and thereby reduces the parts count.

The speed reducing mechanism 13 has a single intermediate roller 20 in the foregoing embodiment, but configurations that have a plurality of intermediate rollers and gradually slow and transfer rotation of the paper feed motor 12 to the paper feed roller 10 through the plural intermediate rollers are also conceivable. In this configuration the encoder scales 32, 35 can be attached to any one of the plural intermediate rollers if the first encoder scale 32 and the second encoder scale 35 are attached to the same intermediate roller.

### Other Encoder Scale Configurations

The speed reducing mechanism 13 can also be configured with an endless belt connecting the first pulley 21 of the paper feed motor 12 and the fourth pulley 24 of the paper feed roller 10. Because this configuration eliminates the intermediate roller 20 from the speed reducing mechanism 13, the first encoder 31 for detecting rotation of the paper feed roller 10 and the second encoder 34 for generating the signal for controlling ink ejection by the inkjet head 3 are provided by mounting the first encoder scale 32 of the first encoder 31 and the second encoder scale 35 of the second encoder 34 on the other axial end of the paper feed roller 10.

The invention being thus described, it will be obvious that it may be varied in many ways. Such variations are not to be regarded as a departure from the spirit and scope of the invention, and all such modifications as would be obvious to one skilled in the art are intended to be included within the scope of the following claims.

What is claimed is:

1. An inkjet line printer comprising:
a paper feed roller that conveys recording paper through a conveyance path past the printing position of an inkjet head;
a paper feed motor that rotates the paper feed roller;
a first encoder that detects the conveyance distance of the paper feed roller;
a second encoder that generates a signal controlling the ink ejection timing of the inkjet head; and
a speed reducing mechanism that slows and transfers rotation of the paper feed motor to the paper feed roller, and has an intermediate roller that rotates at a slower speed than the paper feed motor shaft and a higher speed than the paper feed roller;
wherein a first encoder scale of the first encoder and a second encoder scale of the second encoder are disposed to the intermediate roller.

2. The inkjet line printer described in claim 1, wherein:
the resolution of the first encoder is higher than the resolution of the second encoder.

3. The inkjet line printer described in claim 1, wherein:
the first encoder scale is disposed to a first disk attached coaxially to the intermediate roller; and
the second encoder scale is disposed to a second disk attached coaxially to the intermediate roller at a different position than the first disk in the axial direction of the intermediate roller.

4. The inkjet line printer described in claim 1, wherein:
the first encoder scale of the first encoder and the second encoder scale of the second encoder are disposed at different radial positions on a single disk attached coaxially to the intermediate roller.

5. The inkjet line printer described in claim 1, wherein the speed reducing mechanism includes:
a first pulley attached to the output shaft of the paper feed motor;
a second pulley that is attached coaxially to the intermediate roller and has a larger diameter than the first pulley;
a third pulley that is attached coaxially to the intermediate roller and has a smaller diameter than the second pulley;
a fourth pulley that is that is attached coaxially to the paper feed roller and has a larger diameter than the paper feed roller and the third pulley;
a first endless belt that is mounted on the first pulley and second pulley; and
a second endless belt that is mounted on the third pulley and fourth pulley.
